(19) United States
(12) Patent Application Publication
(10) Pub. No.: US 2008/0068691 A1
(43) Pub. Date: Mar. 20, 2008

(54) OPTICAL SCANNING DEVICE, AND IMAGE FORMING APPARATUS

(76) Inventor: Naoki Miyatake, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/856,289

(22) Filed: Sep. 17, 2007

(30) Foreign Application Priority Data
Sep. 20, 2006 (JP) 2006-254923

(51) Int. Cl. G02B 26/10

(52) U.S. Cl. 359/204

(57) ABSTRACT

An optical scanning device includes a semiconductor laser array is used as the light source, a polygon mirror that has a deflection-reflecting surface and deflects light beams on the deflection-reflecting surface, and a scanning optical system that scans and focuses the light beams on a target surface with a predetermined spacing between the light beams in a sub-scanning direction. The light beams are incident to the deflection-reflecting surface at angles with respect to a normal of the deflection-reflecting surface in the sub-scanning direction, and incident to the deflection-reflecting surface at substantially the same angles in the main scanning direction.

### CROSS-REFERENCE TO RELATED APPLICATIONS

The present application claims priority to and incorporates by reference the entire contents of Japanese priority document, 2006-254923 filed in Japan on Sep. 20, 2006.

### BACKGROUND OF THE INVENTION

1. Field of the Invention

The present invention relates to an optical scanning device, and to an image forming apparatus.

2. Description of the Related Art

Image forming apparatuses such as copiers, facsimile machines, and multifunction products (MFPs) that combine any or all of the functions of copier, facsimile machine, printer, etc. often include an optical scanning device. A typical optical scanning device includes a deflector that deflects light beams from a light source, and a scanning-imaging optical system including an fθ lens that focuses the light beams on a scanned surface to form a light spot thereon. The optical scanning device scans the scanned surface with this light spot (main scanning). The scanned surface refers to a photosensitive surface of photoconductors, such as a photosensitive drum and a photosensitive belt.

One known example of a full-color image forming apparatus includes four photoconductors that are arranged in a feeding direction of a recording sheet. Each photoconductor forms an image of each color component. Such an image forming apparatus includes a plurality of light sources, one for each photoconductor. A flux of light beams emitted from each light source is deflected by a deflector for scanning, and all photoconductors are exposed simultaneously through a plurality of scanning-imaging optical systems each corresponding to one of the photoconductors. Thus, a latent image is formed on the surface of the photoconductors. Then, developers develops the latent image into a visible image utilizing developing powders of different colors, such as yellow, magenta, cyan, and black. These visualized images are sequentially transferred onto a single recording sheet while superimposed one upon another, and a superimposed image is fixed thereon. In this manner, a color image is obtained.

Such an image forming apparatus, known as “tandem image forming apparatus”, generally includes at least two pairs of an optical scanning device and a photoconductor to form a two-color image, a multicolor image, or a full color image. Some tandem image forming apparatuses use a single deflector shared among the photoconductors.

For example, Japanese Patent Application Laid-Open No. H9-54263 discloses a conventional technology in which a deflector deflects light beams substantially parallel to one another and separated in a sub-scanning direction. The light beams are each scanned thorough corresponding one of scanning optical elements arranged in the sub-scanning direction.

Japanese Patent Application Laid-Open Nos. 2001-4948, 2001-10107, and 2001-33720 disclose another conventional technologies in which a scanning-imaging optical system includes three optical elements L1, L2, and L3. Among light beams deflected by a surface of a deflector, light beams directed to different scanned surfaces pass through the optical element L1 and the optical element L2, and each of the light beams directed to a different scanned surface passes through corresponding one of the optical elements L3.

By sharing a single deflector as described above, the number of deflectors can be reduced, resulting in downsizing of an optical scanning device or an image forming apparatus.

Although the number of deflectors can be reduced, if such an optical scanning device is used for a full-color image forming apparatus with scanned surfaces (photoconductors) for four different colors, e.g., cyan, magenta, yellow, and black, the light beams directed to each photoconductor enter the deflector in parallel in the sub-scanning direction, which necessitates an increase in size of the deflector such as a polygon mirror in the sub-scanning direction. Because the polygon mirror is one of the most expensive optical elements in an optical scanning device, this is an impediment to reducing the cost and the size of the entire apparatus.

Japanese Patent Application Laid-Open Nos. 2003-5114 and 2003-21548, for example, disclose another conventional technology enabling cost savings by using a single deflector in an optical scanning device for a color image forming apparatus. The technology employs an oblique-incident optical system, in which light beams are incident to a reflecting surface of the deflector at an angle in the sub-scanning direction, separated from each other and directed toward scanned surfaces (photoconductors) through, for example, a folding mirror. The angle in the sub-scanning direction at which the light beams enter the deflector is set to allow the light beams to be separated. Utilizing the oblique-incident optical system can prevent the deflector from increasing in size, i.e., prevent the number of stages of polygon mirrors or thickness of a polygon mirror from increasing in the sub-scanning direction, while maintaining enough intervals between adjacent light beams in the sub-scanning direction to allow them to be separated by the folding mirror.

However, the oblique-incident optical system has a problem that a scanning line is “curved” for a large extent. In a monochromatic image forming apparatus, if the scanning lines is curved, image quality degrades. Moreover, in a full-color image forming apparatus, because the degree of curvature varies depending on the angle that each light beam has in the sub-scanning direction, when latent images formed with such light beams are visualized into toner images of different colors, and the toner images are superimposed to form a color image, color shift appears in the color image.

Furthermore, oblique incidence increases wavefront aberration. An increase in wavefront aberration leads to degradation of optical performance, especially in image height at the peripheral, and increases a beam-spot diameter, preventing high quality imaging.

For example, Japanese Patent Application Laid-Open No. 2006-72288 has proposed a conventional optical scanning device that can correct the scanning line curvature and the degraded wavefront aberration in the oblique-incident optical system. The conventional optical scanning device includes a scanning-imaging optical system having a plurality of rotating asymmetrical lenses with no curvature factor on the lens surface in the sub-scanning direction. Instead, such a surface has a varying amount of tilt and decenter in the sub-scanning direction along the main scanning direction. By providing at least two of these special surfaces, the wavefront aberration and the scanning line curvature are effectively corrected.

Meanwhile, there are demands for improved writing density that achieves high quality images as mentioned above, and increased output speed in image forming apparatuses. Some proposals have been made to improve the recording speed of an optical scanning device used for a writing system of recording apparatuses such as a laser printer and a laser facsimile machine. One of the proposals suggests increasing the rotation speed of a deflector such as a polygon mirror.

However, increased speed causes other problems such as durability of a motor, noise, vibrations, and modulating speed of a semiconductor laser, limiting the recording speed.

To overcome such limitations, a multi-beam optical scanning device has been proposed to improve the recording speed. The multi-beam optical scanning device scans with multiple optical beams and records multiple lines simultaneously. One example of a multi-beam light source used for the multi-beam light scanning apparatus includes a plurality of semiconductor lasers and a plurality of coupling lenses, each paired with each semiconductor laser, arranged in main scanning direction, and a light source that supports the lasers and lenses in an integral manner. According to such a light source, the light beams are crossed at the proximity of the reflecting surface of the deflector, to reduce the size thereof. In addition, because each deflected light beam is arranged to take an approximately identical light path in the imaging optical system, variation of the optical performance among the light beams is kept small. Moreover, because such a light source (hereinafter, “multi-beam-crossing light source”) uses inexpensive semiconductors and a small number of components, the multi-beam light source, and thus an optical scanning device, can be manufactured at low cost.

There is another problem when a polygon mirror is used as a deflector in an optical scanning device of the oblique-incident optical system with the multi-beam light source that performs multi-beam scanning where a plurality of light beams is written on a single scanned surface simultaneously. Because the polygon mirror is rotated by varying amount of an angle for each light beams for the same image height, optical sag is generated. The optical sag produces a variation of intervals between light beams in the sub-scanning direction (hereinafter, “sub-scanning beam-pitch variation”) depending on the image height. Referring to FIGS. 10 to 13, this problem is now described in details.

The term “Sag” as used herein refers to a phenomenon where a length of a light path becomes different due to change in a reflecting point, which is caused by rotation of the polygon mirror. The term “amount of sag” as used herein refers to a difference in light path lengths.

The problem is described using an example of a multi-beam optical scanning device including a polygon mirror 5 as an deflector and a multi-beam-crossing light source in the oblique-incident optical system, as shown in FIG. 10. The multi-beam optical scanning device includes, in addition to the rotating polygon mirror 5, semiconductor lasers 1-1 and 1-2 as light sources that emit light beams 1a and 2a, a coupling lens 2, a cylindrical lens 3, a drum-shaped photoconductor 7 as an image carrier having a scanned surface 29, scanning lenses L1 and L2 as a scanning-imaging optical system, and a folding mirror 30 that reflects and folds light beams. A main scanning direction 27 is laid perpendicularly to a sub-scanning direction 28.

As shown in FIG. 11, the light beams 1a and 2a, emitted from the semiconductor lasers 1-1 and 1-2 and passing through the coupling lens 2 and the cylindrical lens 3, are incident to a reflecting surface 5a of the polygon mirror 5 at an angle (opening angle) with respect to the main scanning direction 27. To deflect each of the light beams 1a and 2a to the same image height on the scanning surface of the photoconductor 7 for scanning, the polygon mirror 5 needs to be rotated by different angles. However, because the rotation axis 5b of the polygon mirror 5 (see FIG. 10) is not laid on the reflecting surface 5a, optical sag is generated. An angle of 60° shown in FIG. 11 is a typical example of incident angle. It is also noted that, in FIGS. 11 and 13 and FIG. 5 for an embodiment described later, the reference numbers of the semiconductor lasers 1-1 and 1-2 are referenced in parentheses along with the light beams 1a and 2a to indicate their light sources.

In the oblique-incident optical system, as shown in FIG. 12, the amount of sag corresponding to each of the light beams 1a and 2a is different, assuming that, for example, the light beams 1a and 2a emitted from the semiconductor lasers 1-1 and 1-2 are directed to image height of ±150 mm (such sag from a reference point are indicated by “Sag” in FIG. 12). If the difference between these amounts of the sag increases, the pitch d, which is the interval between the deflected light beams 1a and 2a in the sub-scanning direction 28, also becomes different.

Because the light beams 1a and 2a are shifted in the main scanning direction 27 as shown in FIG. 13, the light beams 1a and 2a pass through the scanning lens L1 at different positions. Therefore, in the oblique-incident optical system, because the light path lengths from the reflecting surface 5a to the scanning lens L1 are different, the scanning lines are curved in the sub-scanning direction 28. If the light beams 1a and 2a are shifted in the main scanning direction 27, refractive powers become different in the sub-scanning direction 28 for each of the curved scanning line, and therefore, the positions of the beam spots also become different. In this manner, in a multi-beam system, variation in sub-scanning beam pitch occurs depending on image height. In FIG. 13, the reflecting surface 5a indicated by the dotted line is the reference point for comparison, and 5c indicates the rotating axis of the polygon mirror 5.

In a conventional optical scanning device not of the oblique-incident optical system, light beams are emitted in parallel to a normal line of the reflecting surface, i.e., in perpendicular to the reflecting surface. Under such a setting, the sub-scanning beam pitch, which is caused to be different by the sag the reflecting surface, is kept constant. Furthermore, with regard to the variance in the beam spot positions in the sub-scanning direction on the scanned surface due to the light beam shift in the main direction caused by sag at the polygon mirror, such variance is kept small because the scanning line is not curved in the sub-scanning direction.

As described above, a multi-beam in the oblique-incident optical system can cause the problems of the sub-scanning beam-pitch variation, due to the light beam shift in the main scanning direction, caused by the sag at the rotating polygon mirror. Specifically, the sub-scanning beam pitch widens from one side of the image height toward the other. In the oblique-incident optical system used for a full-color image forming apparatus, when light beams of different colors to be superimposed differ from each other between the semiconductor lasers 1-1 and 1-2, color shift increasingly occurs in the sub-scanning direction at the peripheral image height, which degrades image quality.

### SUMMARY OF THE INVENTION

It is an object of the present invention to at least partially solve the problems in the conventional technology.

According to an aspect of the present invention, an optical scanning device includes a deflector that has a deflection-reflecting surface, and deflects light beams on the deflection-reflecting surface; and a scanning optical system that scans and focuses the light beams on a target surface with a predetermined spacing between the light beams in a sub-scanning direction. The light beams are incident to the deflection-reflecting surface at angles with respect to a normal of the deflection-reflecting surface in the sub-scanning direction, and incident to the deflection-reflecting surface at substantially identical angles in a main scanning direction.

According to another aspect of the present invention, an optical scanning device includes a light source that emits light beams; a deflector that has a deflection-reflecting surface, and deflects the light beams on the deflection-reflecting surface; a scanning optical system that scans and focuses the light beams on a target surface with a predetermined spacing between the light beams in a sub-scanning direction. The light beams are incident to the deflection-reflecting surface at angles with respect to a normal of the deflection-reflecting surface in the sub-scanning direction, and incident to the deflection-reflecting surface at different angles in a main scanning direction such that the light beams intersect one another at a position in proximity of the deflection-reflecting surface. The position is in between where a distance from the light source to a point on the deflection-reflecting surface from which the light beams are deflected is shortest and where the distance is longest upon rotation of the deflector to deflect the light beams.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an optical scanning device according to a first embodiment of the present invention;

FIGS. 2, 3A and 3B are schematic diagrams of light sources and a beam-combining unit in an optical scanning device according to a second embodiment of the present invention;

FIG. 4 is an exploded perspective view of an optical scanning device according to a third embodiment of the present invention;

FIG. 5A is a schematic diagram of light paths for explaining a problematic phenomenon in an optical scanning device with a multi-beam-crossing light source;

FIG. 5B is a schematic diagram of light paths according to the third embodiment;

FIG. 6A is a perspective view of a unidirectional scanning system optical scanning device according to a fifth embodiment of the present invention;

FIG. 6B is a front view of the unidirectional scanning system optical scanning device;

FIG. 7A is a schematic diagram of a conventional unidirectional scanning system optical scanning device of not oblique-incident optical system;

FIG. 7B is a schematic diagram for explaining light paths of light beams according to the embodiments;

FIG. 8 is a schematic diagram for explaining a scanning line curvature due to a shape of a scanning lens used in an oblique-incident optical system;

FIG. 9 is a schematic diagram of an image forming apparatus with the optical scanning device of the embodiments;

FIG. 10 is a perspective view of a conventional multi-beam optical scanning device of oblique-incident optical system that uses a polygon mirror, and a multi-beam-crossing light source;

FIGS. 11 and 12 are schematic diagrams for explaining a problem in variable amount of sag according to a conventional technology; and

FIG. 13 is a schematic diagram of light paths for explaining a problematic phenomenon that light beams for the same image height pass through a scanning lens at different positions due to a sag.

### DETAILED DESCRIPTION OF THE PREFERRED EMBODIMENTS

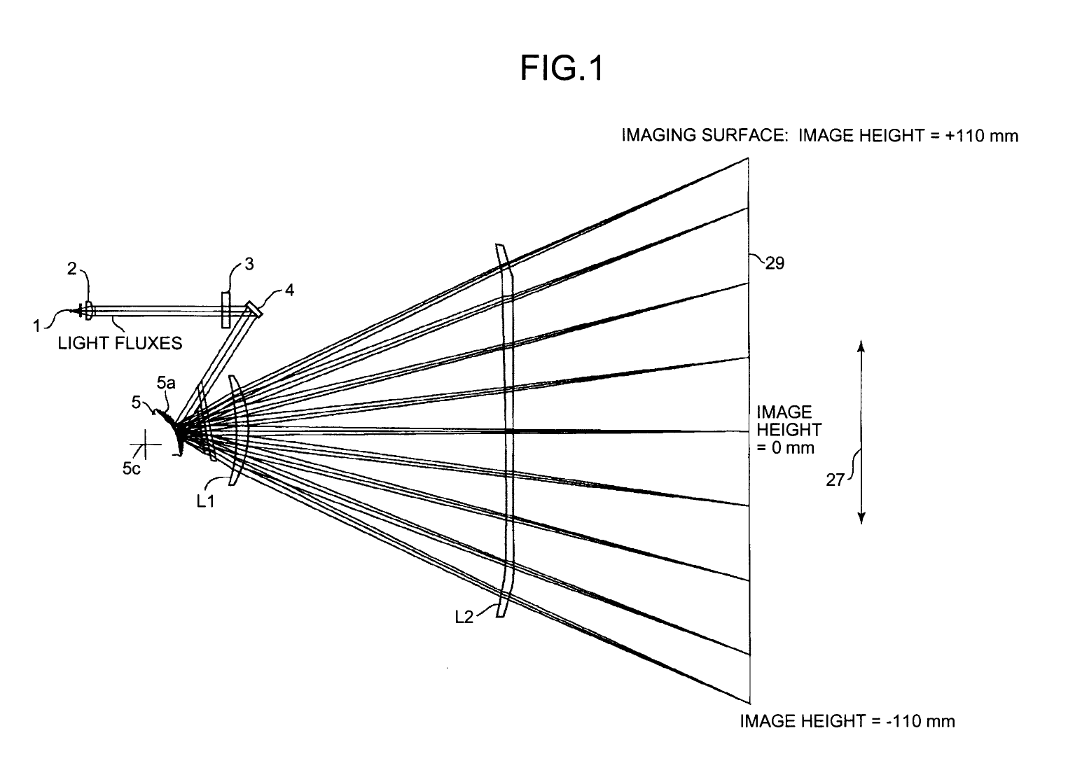

Exemplary embodiments of the present invention are explained in detail below with reference to the accompanying drawings. Like reference numerals refer to corresponding portions throughout the drawing, and the same explanations are not repeated. Some elements are not shown in the drawings for simplicity of illustration. FIG. 1 is a schematic diagram of an optical scanning device according to a first embodiment of the present invention. The optical scanning device includes a semiconductor laser 1 as a light source that emits a light flux (light beams) with divergent quality, and a coupling lens 2 that couples the light flux into a form suited for a subsequent optical system. The light flux can be a parallel one as shown in FIG. 1, or have slight divergent or convergent quality.

The light flux from the coupling lens 2 is focused on a cylindrical lens 3 in the sub-scanning direction, then folded and reflected on a folding mirror 4 to the reflecting surface of a deflector. The light flux is focused and incident to the reflecting surface of the deflector.

In the first embodiment, the polygon mirror 5 is used as a deflector that is driven to rotate at a constant high speed. The light beams as a light flux is focused and incident to the reflecting surface 5a. As shown in FIG. 1, the light flux emitted from the semiconductor laser 1 enters the polygon mirror 5 at an angle with respect to the normal line of the reflecting surface 5a in the sub-scanning direction (in FIG. 1, the direction vertical to a sheet surface perpendicular to the main scanning direction 27).

To cause light beams to be incident at an angle with respect to the normal line of the reflecting surface 5a in the sub-scanning direction, i.e., to cause light beams to be incident obliquely with respect to the sub-scanning direction, the light source (the semiconductor laser 1), the coupling lens 2 or the cylindrical lens 3 can be arranged at a desired angle, or use the folding mirror 4 to give such an angle. Alternatively, the light axis of the cylindrical lens 3 can be shifted toward the sub-scanning axis so to give an angle to the light beam traveling to the reflecting surface 5a.

In the first embodiment, the cylindrical lens 3 is referred to as a first optical system, and a scanning-imaging optical system, including scanning lenses L1 and L2, are referred to as a second optical system. Both the first and the second optical systems include a scanning optical system described below.

The light flux reflected on the reflecting surface 5a is deflected at a constant speed according to the constant rotation speed of the polygon mirror 5, passes through the scanning lenses L1 and L2 of the scanning-imaging optical system, and is collected at the scanned surface (target surface) 29. In this manner, the light flux forms a light spot on the scanned surface 29, and scans the scanned surface 29. The reflecting surface 5a and the scanned surface 29 are in a conjugate relation in the sub-scanning direction, and form an optical system that corrects the tilt on the reflecting surface 5a in the sub-scanning direction.

For the purpose of explanation, the light beams in the form of a light flux shown in FIG. 1 is described above as a single beam; however, actually, a plurality of light beams are incident to the same scanned surface. Each of the light beams is incident at an angle in respect to the normal line of the reflecting surface 5a in the sub-scanning directions as described above. Furthermore, to obtain desired intervals between the light beams on the scanned surface 29 in the sub-scanning direction, a very small distance and an angle are given in between the respective light beams in the sub-scanning direction. In FIG. 1, plate-like elements are provided in between the folding mirror 4 and the polygon mirror 5, and also in between the polygon mirror 5 and the scanning lens L1. These are elements made of soundproof glass, provided to reduce wind noise generated by polygon mirror 5.

If the multi-beam is used in a conventional oblique-incident optical system to improve the speed and the density, the sub-scanning beam-pitch variation will be an issue as explained above, for the reasons that are also explained above. A polygon scanner using a polygon mirror has advantages that the reflecting surface can be thinner in the sub-scanning direction by using oblique-incident optical system. Therefore the cost of the polygon scanning apparatus, which takes up a fair share of the optical scanning device, can also be lowered. In addition, inertia in the rotating body can be reduced, further reducing windage loss, which, in turn, contributes to reduce the power consumption. However, improvement in speed and density has been difficult.

Therefore, in the optical scanning device according to the first embodiment, the light beams are incident to the same reflecting surface of the deflector with the same angle with respect to the main scanning direction. In this manner, the light beams are reflected on the polygon mirror with the same angle and directed to the same image height.

One example is described below, in which a semiconductor laser array is used as the light source 1. As mentioned above, the sub-scanning beam-pitch variation occurs in the multi-beamed, oblique-incident optical system mainly due to the optical sag generated at the polygon mirror. According to the first embodiment, utilization of the semiconductor laser array as the light source 1 enables the light beams to be incident to the same reflecting surface of the deflector with the same angle in the main scanning direction. In this manner, the optical sag, generated in deflection of the light beam, can be reduced. According to the first embodiment, because the light beams from the semiconductor laser array enter the polygon mirror, for example, in a form of a parallel light flux, with the same angle with respect to the main scanning direction 27, the polygon mirror 5 is rotated by the same angle upon reflecting the light beams to the same image height on the scanned surface 29. In other words, no optical sag is generated by rotating the polygon mirror 5 in deflecting the respective light beams to the same image height for scanning. By using the same rotation angle to deflect each of the light beams destined to an image height toward the main scanning direction 27, the interval variation between the respective light beams on the reflecting surface 5a is minimized. Furthermore, using the same rotation angle can also prevent the respective light beams, which travel to the same image height, from being shifted in the main scanning direction 27, allowing each light beams to go through the scanning lenses L1 and L2 at the same point.

As explained above, in the oblique-incident optical system, the scanning line is curved in the sub-scanning direction, due to the variation in the light path length between the reflecting surface and the scanning lens. Therefore, if the light beams are shifted in the main scanning direction, the refractive powers become different in the sub-scanning direction, and also the position of the beam spots becomes different in the sub-scanning direction. Difference in the beam spot positions causes the sub-scanning beam-pitch variation depending on image height, i.e., a variance is generated, in a multi-beam system. Furthermore, because magnification ratio of the scanning optical system remains constant for each image height, if the intervals between each of the deflected light beams, reflected on the polygon mirror, destined to a predetermined image height become varied, then the light beam intervals on the scanned surface also become varied in the sub-scanning direction, i.e., sub-scanning beam pitch also varies. Although it is possible to change the magnification ratio in the main scanning direction depending on the variation in the deflected light beam intervals, varying magnification ratio can cause the beam spot diameter variation in the sub-scanning direction. Variation in the beam spot diameter, in turn, can lead to deterioration in imaging quality.

According to the first embodiment, the above problems are easily solved by using the laser array for the light source 1. In other words, to obtain a desired sub-scanning beam pitch on the scanned surface 29, with the sub-scanning magnification ratio in the optical system between the light source 1 and the scanned surface 29 and intervals between the luminous points in the semiconductor laser array, the luminous points in the semiconductor laser array may be arranged either in perpendicular to, or at an angle with respect to the main scanning direction 27. If the luminous points in the semiconductor laser array are arranged in perpendicular to the main scanning direction 27, the light beams are incident to the same surface 5a with the same angle with respect to the main scanning direction 27. Therefore, variation in the sub-scanning beam pitch can be reduced without being influenced by sag generated at the polygon mirror 5, as explained above.

If the luminous points in the semiconductor laser array are arranged at an angle with respect to the main scanning direction 27, each of the light beams is angled by a different degree with respected to the main scanning direction 27 at the position the light beam passes through the same coupling lens 2. However, the intervals between the luminous points in the semiconductor laser array are a between a dozen to a few tens of micrometers, the difference in such angles are very small. Therefore, the light beams are incident to the same reflecting surface 5a with slightly different angles, enabling to minimize the effect of the sag at the polygon mirror 5 and to reduce the variation in the sub scanning beam pitch. Specifically, these advantages can be realized when a semiconductor laser array with luminous points whose intervals are 100 micrometers or less.

According to the first embodiment, the shift of light beams in the main scanning direction 27 and the intervals between the deflected light beams can be maintained uniform or approximately uniform for any image height. In this manner, the variation in sub-scanning beam pitch, which is a unique problem in the oblique-incident optical system, can be reduced greatly.

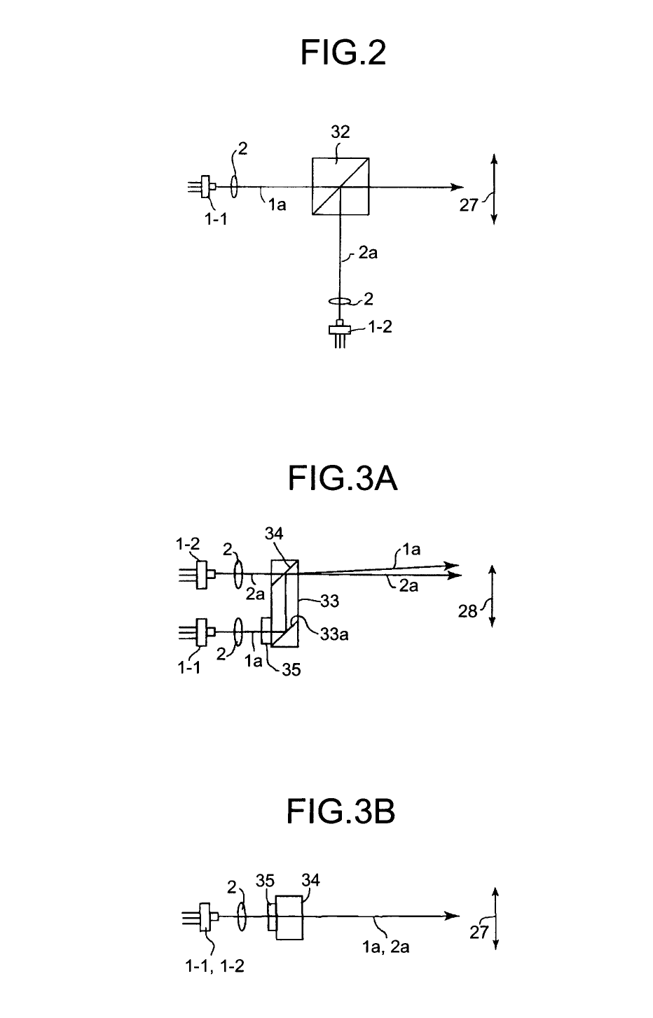

FIGS. 2, 3A and 3B are schematic diagram of semiconductor lasers 1-1 and 1-2 that emit light beams such that they are incident to the same reflecting surface of the deflector at the same angle with respect to the main scanning direction according to a second embodiment of the present invention.

The first embodiment employs a semiconductor laser array as a light source. An optical scanning device of the second embodiment includes a plurality of the semiconductor lasers 1-1 and 1-2.

Referring to FIG. 2, one example of the light source structure is explained below. In the second embodiment, a prism 32 is used as a beam-combining unit that brings the light beams closer to each other in the main scanning direction 27. As shown in FIG. 2, the semiconductor lasers 1-1 and 1-2 are arranged separately. Each coupling lens 2 converts each of the light beams 1a and 2a, respectively emitted from the semiconductor lasers 1-1 and 1-2 into a desired form, i.e., for example, parallel, diverging, or converging light. The converted lights are incident to the prism 32, i.e., a beam-combining unit. Each light is combined into a direction corresponding main scanning direction 27, and incident to the same reflecting surface of a polygon mirror, i.e., a deflector (not shown). At this point, the light beams have a slight distance and an angle in the sub-scanning direction to obtain a desired amount of intervals between the light beams on the scanned surface.

In the light source shown in FIG. 2, if the position of each of the semiconductor lasers 1-1 and 1-2, or the coupling lens 2 become offset, especially in the sub-scanning direction, the emitting direction of each of the semiconductor lasers 1-1 and 1-2 must be adjusted individually. In addition, because each light source is arranged separated from each other, they are subjected to a large offset over time, e.g., due to variations in temperature. Therefore, it is difficult to keep constant beam spot intervals.

In consideration of these issues, the light source can alternatively be arranged as shown in FIG. 3. The light source includes the semiconductor lasers 1-1 and 1-2 as light sources, coupling lenses 2 corresponding to the semiconductor lasers 1-1 and 1-2, a prism 33 that combines light beams 1a and 2a emitted from the semiconductor lasers 1-1 and 1-2, and a half-wavelength plate 35.

Each of the semiconductor lasers 1-1 and 1-2 are arranged in the sub-scanning direction 28 and supported on the same supporting member (not shown). The supporting member also supports the coupling lenses 2, provided for each of the semiconductor lasers 1-1 and 1-2. The coupling lenses 2 are adjusted so that desired intervals are given between the light beams in the sub-scanning direction on the scanned surface. The semiconductor laser 1-1 and the coupling lens 2 including a first light source, and the semiconductor laser 1-2 and the coupling lens 2 including a second light source, respectively.

The half-wavelength plate (λ/2 plate) 35 is arranged on the surface of the prism 33 to which the light beam 1a, emitted from the first light source is incident. The light beam 1a from the first light source passes through the half-wavelength plate 35, with polarized direction rotated by 90 degrees, reflected on the reflection surface 33a in the prism 33. Then, the light beam 1 is further reflected on a polarizing beam splitter surface 34, and incident to a proximity of the light beam 2a emitted from the second light source and passing through the polarizing beam splitter surface 34. Because the respective semiconductor lasers 1-1 and 1-2 are arranged to overlap at the main scanning direction 27, the respective light beams 1a and 2a are overlapped in a direction corresponding to the main scanning direction 27, and incident to the same reflecting surface of a polygon mirror (not shown).

Two light sources shown in FIGS. 2 and 3 are explained above as examples. However, any light source can be used that emits light beams in such a manner that the light beams are incident to the same reflecting surface of a deflector at substantially the same angles with respect to the main scanning direction. In this manner, the sub-scanning beam-pitch variation, a problem unique to the oblique-incident optical system, on the scanned surface can be reduced.

In the examples of the first and the second embodiments described above, the light beams are explained as scanning the same scanned surface 29 of a single photoconductor. However, the optical scanning device can also be used for at least two photoconductors, i.e., optically scanning different scanned surfaces. A color image forming apparatus including such an optical scanning device is described later.

A third embodiment of the present invention relates to an optical scanning device where each of a plurality of light beams that are directed to the same scanned surface cross at the proximity of a reflecting surface, at a different angle with respect to the main scanning direction, upon entering a deflector.

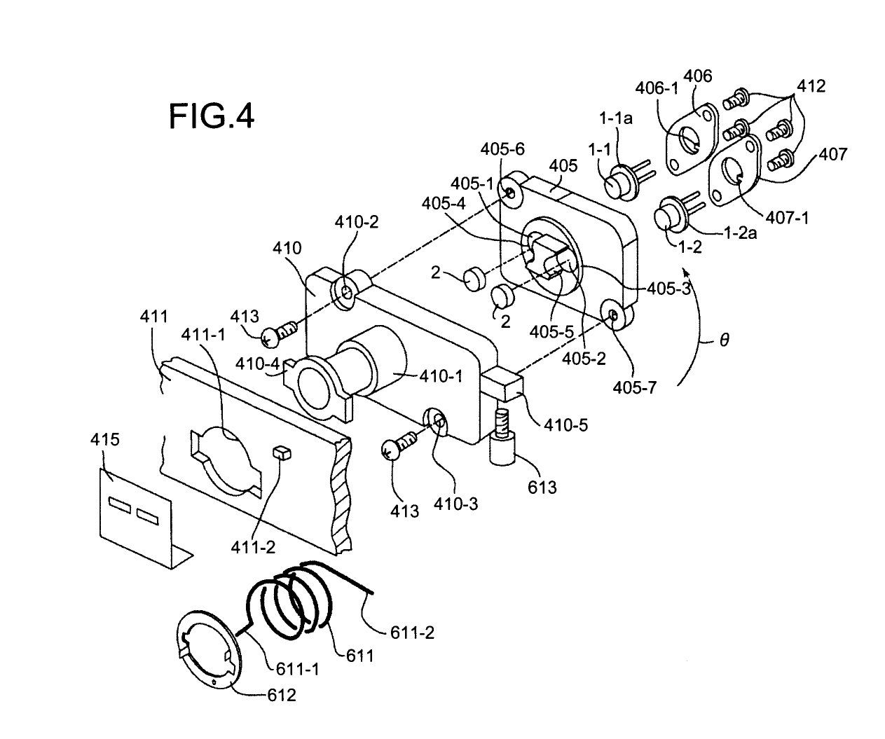

As an example, a multi-beam-crossing light source is explained. In FIG. 4, the semiconductor lasers 1-1 and 1-2 engage into the engaging holes 405-1 and 405-2, respectively, penetrating through a base member 405. The engaging holes 405-1 and 405-2 are given a slight angle, approximately 1.5° in the third embodiment, with respect to the main scanning direction. Therefore, the semiconductor lasers 1-1 and 1-2, which are engaged into the engaging holes 405-1 and 405-2, are also given the angle of approximately 1.5° with respect to the main scanning direction. The semiconductor lasers 1-1 and 1-2 have a cylinder-shaped heat sink element 1-1a and 1-2a, respectively, on which a cutoff is formed. These cutoffs are engaged with small projections 406-1, 407-1 provided on the internal perimeter of central circular holes in the holding members 406, 407 that fix the light sources in particular directions. By fastening the holding members 406, 407 to the base member 405 with screws 412 from rear side thereof, the semiconductor lasers 1-1 and 1-2 are fixed to the base member 405 as well. To adjust the direction of the light axes, collimating lenses 2 are provided along the surfaces of semicircular attachment guides 405-4 and 405-5, with perimeter thereof contacting to such guides. The collimating lenses 2 are aligned so that the diverging lights emitted from the luminous points are converted into parallel light fluxes, then the entire arrangement is adhered together.

In the above example, to arrange the light beams from the semiconductor lasers 1-1 and 1-2 so as to cross on the sub-canning plane, the engaging holes 405-1 and 405-2 and the attaching surfaces of the semicircular attachment guides 405-4 and 405-5 are arranged at an angle with respect to the direction of the light beam emission. A cylinder-shaped engaging element 405-3 is engaged with a holder member 410, and screws 413 are screwed into screw holes 405-6, 405-7 via through-bores 410-2, 410-3 to fix the base member 405 to the holder member 410.

The holder member 410 of the above light source 36 has a cylinder-shaped element 410-1. An optical housing has an attaching wall 411 that is provided with a reference hole 411-1, engaged with the cylinder-shaped element 410-1. A spring 611 is inserted from the outside of the attaching wall 411, and the cylinder-shaped element 410-1 is fixed with a stopper member 612, holding the cylinder-shaped element 410-1 in contact with internal surface of the attaching wall 411. In this manner, the light source 36 is held against the attaching wall 411. One end 611-2 of the spring 611 is grappled onto a projection 411-2 at the attaching wall 411, and the other end 611-1 is grappled onto the light source 36. In this manner, a rotating force is generated around the axis of the cylinder-shaped element 410-1 in the light source 36. An adjustment screw 613 is provided to withhold such a rotating force, and held in contact with a contacting element 410-5 formed in integral with the holder member 410. In this arrangement, pitch can be adjusted by rotating the entire light source 36 in the direction of θ around the light axis. In front of the light source 36, an aperture 415 is provided having two slits, one for each of the semiconductor lasers 1-1 and 1-2. The aperture 415 is attached on the above-mentioned optical housing, so to define the diameter of the projected light beams.

In the optical scanning device of the third embodiment, the light beams enter the polygon mirror with angles with respect to the normal line of the reflecting surface of the deflector in the sub-scanning direction. At the same time, the light beams cross each other at the proximity of the reflecting surface in different angles in the main scanning direction.

In the third embodiment, the light beams enter the deflector so that they cross each other at the proximity of the reflecting surface in different angles with respect to the main scanning direction. Therefore, the polygon mirror is also rotated for different angles to direct the light beams to the same image height, generating optical sag in the light beams traveling to the scanned surface. The sag effect causes each light beam destined to the same image height to shift in the main scanning direction. This shift, in turn, causes each light beam to pass through the scanning lens at different points. Then again, in the oblique-incident optical system, variation in the light path length causes scanning lines to be curved in the sub-scanning direction. Therefore, if the light beams shift in the main scanning direction, the refractive powers become different in the sub-scanning direction, and the positions of the beam spots become different. Difference in the positions of the beam spot results in sub-scanning beam pitch to vary depending on the image height, i.e., a variance is generated, in a multi-beam unit.

Thus, in the third embodiment, the light beams need to be arranged to cross in the main scanning direction between two points where the distance from each light source of the light beams to the reflecting surface becomes shortest and where such a distance becomes longest, as the polygon mirror is rotated to deflect the light beams.

The amount of sag changes as the polygon mirror is rotated to deflect the light beams from the points where the distance from each light source of the light beams to the reflecting surface becomes longest to the point where such a distance becomes shortest.

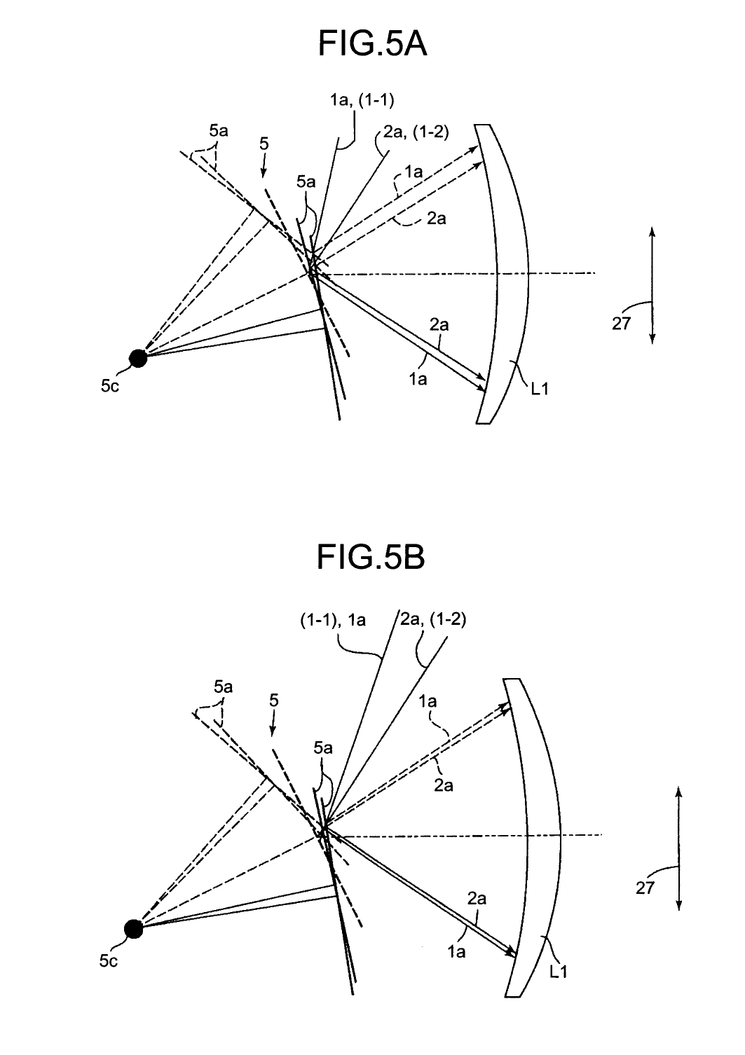

In FIG. 5A, the light beams 1a and 2a cross at the point where the distance from the light sources of the light beams 1a and 2a (the semiconductor lasers 1-1 and 1-2) to the reflecting point is at its longest. In this example, a different amount of sag is generated for each of the light beams 1a and 2a because the polygon mirror is rotated for different angles to direct the light beams 1a and 2a to the same image height. Therefore, each of the light beams 1a and 2a is reflected at a position on the reflecting surface that is shifted along the light paths in the main scanning direction 27. In other words, such an amount of shift varies depending on the image height, because the reflecting point for each of the light beam 1a and 2a is shifted along the light paths in the main scanning direction 27 as the polygon mirror 5 is rotated to scan the scanned surface in main scanning direction 27. That is, because the light beams 1a and 2a, deflected to scan the same image height on the scanned surface, are shifted for varying amount in the main scanning direction 27, the sub-scanning beam-pitch variation is increased as explained above.

In the third embodiment, because the light beams 1a and 2a are arranged to cross in the main scanning direction 27 between two points where the distance from each light source of the light beams 1a and 2a (the semiconductor lasers 1-1 and 1-2) to the reflecting surface becomes shortest and where such a distance becomes longest, as the polygon mirror 5 is rotated to deflect the light beams 1a and 2a. Therefore, the amount of shift between the light beams 1a and 2a, caused by influence of sag, can be adjusted to be reduced toward the crossing point, then again to be increased as shown in FIG. 5B.

Valid writing width on the scanned surface, i.e., the length of the scanning lines in the main scanning direction is specified for each apparatus. In the same manner, the rotating angle, required for the deflection for scanning, of the polygon mirror is also specified in each scanning optical system supporting such an apparatus. By setting the point where each light beam cross each other in the main scanning direction between two points where the distance from each light source of the light beams to the reflecting surface becomes shortest and where such a distance becomes longest, the maximum amount of the shift caused by sag can be reduced. As a result, the amount of shift, in the main scanning direction, between a plurality of light beams that are deflected to the same image height on the scanned surface can be reduced, further reducing the beam-pitch variation.

As described above, in an optical scanning device in which a plurality of light beams, directed toward the same scanning surface, enter a polygon mirror, i.e., a deflector, with different angles with respect to the main scanning direction so as to cross at the proximity of the reflecting surface, the sub-scanning beam-pitch variation can be reduced by arranging the light beams so as to cross between two points where the distance from each light source of the light beams to the reflecting surface becomes shortest and where such a distance becomes longest, as the polygon mirror is rotated to deflect the light beams.

Furthermore, to minimize the sub-scanning beam-pitch variation, it is advantageous to arrange the light beams, crossing at the proximity of the reflecting surface each with different angles, so that difference in such angles is reduced. By reducing such angle, the angle of the polygon mirror rotated to direct the light beams to the same image height on the scanned surface can be reduced, thus, reducing the effect of sag.

According to the third embodiment, in the light source shown in FIGS. 4 and 5B, to reduce the angle of light beams 1a and 2a in the main scanning direction 27, the luminous points for each of the light beams 1a and 2a must be brought closer, or the polygon mirror 5 must be further separated from the light source. However, it is difficult to reduce the distance between the luminous points more than a certain extent, because of limitations such as the size of the package for the semiconductor lasers 1-1 and 1-2, or shapes of the coupling lenses 2. Furthermore, it is not preferable to arrange the polygon mirror 5 further away from the light source, because such an arrangement leads to increase in size of the optical scanning device.

Therefore, the angle of the light beams is reduced with respect to the main scanning direction by providing a beam-combining unit to bring the light beams closer in the main scanning direction, or to separate the light beams further away in the main or sub-scanning direction.

One example of a light source having the beam-combining unit is basically the same as the ones explained for the second embodiment in connection with FIGS. 2 and 3. Therefore, the same explanation is not repeated. The light source is only different from those of the second embodiment in that the light sources alone, or light sources and coupling lenses together, are arranged so that a plurality of light beams cross at the proximity of the reflecting surface with different angles with respect to the main scanning direction. By reducing the angle of the light beams in the main scanning direction, shift in the light beams in the main direction can be reduced. In this manner, the sub-scanning beam-pitch variation, which is unique problem in the oblique-incident optical system, can be greatly reduced.

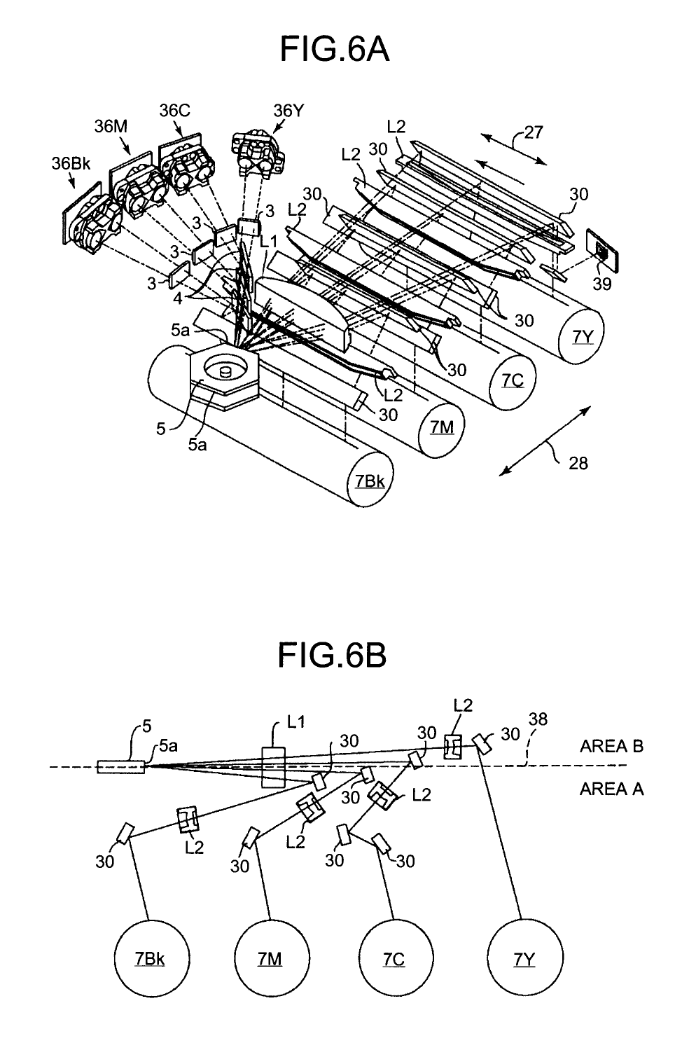

Furthermore, because the light beams are angled with respect to the main scanning direction, signals, corresponding to each light beam, is individually taken out, for example in a synchronous photodiode (PH) 39 shown in FIG. 6B, to decide a point to start writing on he scanned surface, achieving stable imaging quality.

An optical scanning device that scans a plurality of sets of light beams is explained below. As an example, unidirectional scanning system optical scanning device is explained referring to FIGS. 6A and 6B.

In FIGS. 6A and 6B, a plurality of sets of light beams emitted from respective light sources 36Bk, 36M, 36C, and 36Y are incident at an angle to the same reflecting surface 5a of the same polygon mirror 5 (such a plurality of light beams are shown as a single light beam in FIGS. 6A and 6B). Each set of the light beams are incident to both areas (areas A and B in FIG. 6B) located at each side of the normal line 38 (shown as a dotted line in FIG. 6B) of the reflecting surface 5a. Every set of the light beams passes through a common scanning lens L1, is separated by the folding mirrors 30, and directed to each photoconductor 7Bk, 7M, 7C, and 7Y, i.e., a corresponding scanned surface. In the example of the fourth embodiment, scanning optical system includes a first lens and a plurality of second lenses, and a second scanning lens L2 is provided for each set of the light beams directed to the corresponding scanned surface.

FIG. 6A depicts the double-stage polygon mirror 5. However, for the purpose of reducing the cost and power consumption, a single-stage polygon mirror 5, as shown in FIG. 6B, is preferred to reduce the thickness.

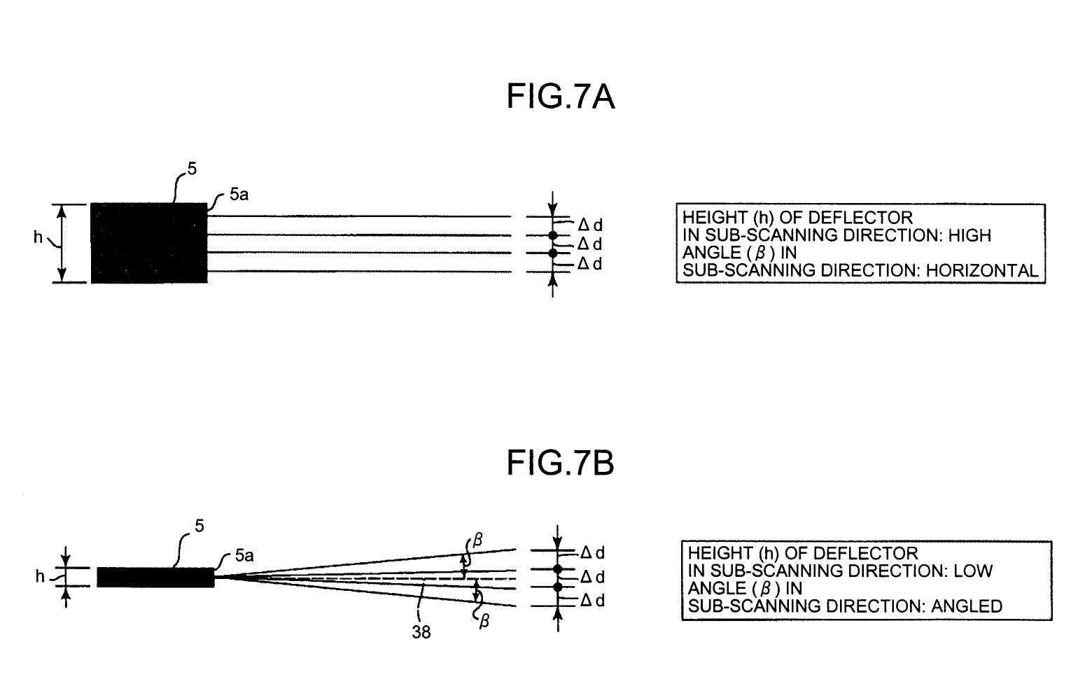

FIG. 7A is a schematic diagram of a conventional unidirectional scanning system optical scanning device of not oblique-incident optical system where each set of light beams is arranged in parallel with the normal line of the reflecting surface 5a. Although this type of optical scanning device achieves high optical performance, each set of the light beams from each light source, each directed to a different scanned surface, must be separated by an interval Δd, usually 3 mm to 5 mm, to enable separation of each set of the light beams. Therefore, the height h (in the sub-scanning direction) of the polygon mirror increases. As the height h increases, the area in contact with the atmosphere is also increased, causing, in turn, increased power consumption due to windage loss, noise, and cost. Especially the cost is a problem because the deflector takes up a fairly large share of cost in an optical scanning device.

According to the above embodiments, as shown in FIG. 7B, a plurality of sets of light beams are reflected on the reflecting surface 5a, and incident to the scanning lens L1 at an angle β (in the sub-scanning direction). In this manner, the height h of the polygon mirror 5 can be reduced. A polytope forming the reflecting surface 5a can be arranged in a single layer, and the thickness in the sub-scanning direction can be reduced. This in turn enables inertia, as well as the start up time, to be reduced. In this manner, the low-cost optical scanning device with low power consumption is achieved.

However, in the optical scanning device, every set of light beams is given an angle with respect the normal line of the reflecting surface of the deflector in the sub-scanning direction. Therefore, it is necessary to cause the light beams to be incident at a large angle in the sub-scanning direction. As explained above, to maintain enough interval between each set of the light beams directed to each corresponding scanned surface for separation of each of the light-beam sets, the light-beam sets are incident at a greater angle, at least for those light-beam sets arranged nearest to and farthest from the scanned surface in the sub-scanning direction. This, in turn, causes the scanning lines to become curved in a greater degree.

The scanning lines are curved in the oblique-incident optical system in the manner explained below. For example, in FIGS. 6A and 6B, the scanning lenses L2 (in FIG. 1, the second scanning lens L2) have a stronger refractive power, especially in the sub-scanning direction, than the other scanning lens of the scanning-imaging optical system. Unless the incident surface of the lens L2 has a curved shape, in the main scanning direction, with its center at the reflecting point of the deflector where the light-beam sets are reflected, the distance from the reflecting surface of the polygon mirror to the incident surface of the scanning lens L2 become variable, depending on the height in the lenses. Usually, it is difficult, from a perspective of optical performance, to form the scanning lens in such a shape as described above. Therefore, the deflected light-beam sets are usually not incident perpendicularly to the lens surface, but at a predetermined incident angle with respect to in the main scanning direction, on a surface intersected at a predetermined image height, as shown in the scanning lens L2 of FIG. 1.

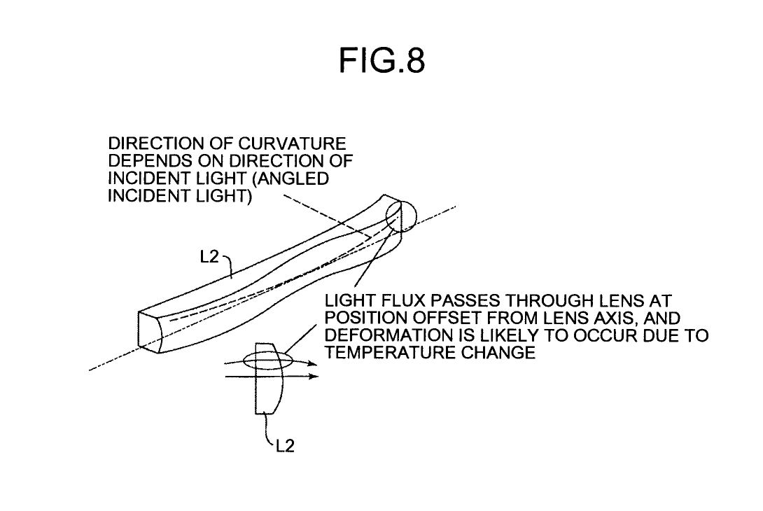

Because each light-beam set has an angle with respect to the sub-scanning direction (oblique incidence), each deflected light beam takes a light path of different length, from the reflecting surface of the polygon mirror to the incident surface of the scanning lens, depending on the image height. As shown in FIG. 8, the closer to the periphery of the scanning lens L2, the higher or the lower (depending on the direction of the angle of each light-beam set with respect to the sub-scanning direction) the incident height of the light-beam set becomes in the sub-scanning direction compared with the center. As a result, upon incident to a surface with a refractive power in the sub-scanning direction, each scanning line is curved by a different degree due to the varying refractive power each scanning line receives in the sub-scanning direction. In the conventional optical system where the light beams are emitted in parallel, each light beam travels horizontally to the scanning lens, and is incident to the scanning lens at the same position in sub-scanning direction. Therefore, curvature of the scanning line does not occur.

Also, temperature change varies the amount of curvature of the scanning lines as described below. Recently, scanning lenses are often made from plastics, in consideration of cost and freedom in designs of the lens shapes (those other than spherical surface). However, a plastic lens changes its shape more easily by temperature change compared with a glass lens.

As explained above, in the oblique-incident optical system, the light-beam sets are curved in the sub-scanning direction upon entering the scanning lens. Therefore, if the temperature change causes curvature radius or thickness of the scanning lens, angle at which the light-beam sets are incident to the scanning lens, or positions thereof in sub-scanning to become different, variation in the refraction also occurs, further curving the scanning lines in the sub-scanning direction. In the same way as that explained above, if the light-beam sets are emitted horizontally as in a conventional manner, the light-beam sets travels horizontally to the scanning lens even if the distance from the reflecting surface to the incident position on the scanning lens become different. Therefore, the light-beam sets are emitted approximately at the height of a light axis and remain constant, thus causing very little amount of the scanning line curvature. In other words, because the light-beam sets pass through the lens on the bus line, even if the temperature change causes variation in the curvature radius, the light-beam sets are not refracted at all, or only slightly refracted, although the imaging position (defocused direction) may change. Therefore, variation in curvature of the scanning lines in the sub-scanning direction is kept very small.

As explained above, large curvature in the scanning lines is a problem unique to the oblique-incident optical system. The curvature direction differs depending on which side a normal line of the reflecting surface the light beams are located at. In other words, if the sets of light beams are emitted from the area A in FIG. 6B, they curves in a opposite direction from those emitted from the area B. This is because, as shown in FIG. 8, the curvature of the scanning lines for the scanning lens L2 is reversed in direction depending on the angle at which the light beams enter the scanning lens L2 in the sub-scanning direction, i.e., oblique incidence of the light beams (if the light beams enter from the area A, or the area B in FIG. 6B). The scanning line curvature is mainly caused by the scanning lens L2 having a refractive power especially strong in the sub-scanning direction.

In the similar manner, also under temperature change, variations in the curvature of the scanning lines are reversed on both sides of the normal line of the reflecting surface. If the scanning lines are curved in a reversed direction on different scanned surfaces, when each color is layered one over the other, the colors end up being shifted, prominently degrading the quality of the color quality. The greater angle the light-beam set is incident at to the scanning lens, the more curved the scanning line will be. In other words, the scanning lines from the two sets of light beams located outside are curved more than those two located inside. Furthermore, the scanning lines from the external sets of the light beams are subjected to greater curvature under temperature change.

It is known that the scanning line curvature or the wavefront aberration due to the oblique incidence can be corrected by a surface with no curvature factor on the lens surface in the sub-scanning direction, but instead, having a variable amount of tilt and decenter of the sub-scanning direction along the main scanning direction. However, such a surface cannot correct the curvature of the scanning lines due to the temperature change as explained above, resulting in colors being layered with a shift.

The optical scanning device disclosed in Japanese Patent Application Laid-Open No. 2006-72288 is provided with a plurality of sets of light beams arranged in parallel to the normal line of the reflecting surface of the deflector, and those arranged at an angle to the normal line of the reflecting surface of the deflector, to reduce the incident angle. This arrangement enables the curvature of the scanning line to be reduced. However, such an optical scanning device requires a larger deflector such as that shown in FIG. 7A (due to multi-layered or thick polygon mirror 5). This, in turn, causes the height h (in the sub-scanning direction) of the deflector (polygon mirror 5) to increase, further increasing the area in contact with the atmosphere, causing increase of power consumption due to windage loss, noise, cost, or the size of the optical scanning device.

According to the embodiments, each light-beam set is directed to a different scanned surface via the folding mirrors 30 as shown in FIGS. 6A and 6B, and such folding mirrors 30 are different in numbers by an odd number, at least between the folding mirrors 30 for the light-beam set located closest to the scanned surface in the scanning direction, and those for the light-beam set located farthest. The scanning lines, folded by the folding mirrors 30 in the sub-scanning direction, are reversed in the sub-scanning direction 28. Therefore, even if the scanning lines are curved in different directions between both sides of the normal line 30 of the reflecting surface 5a, as explained in reference to FIGS. 6B and 7B, the scanning lines can be corrected to the same direction. By matching the direction of those light-beam sets located at the closest and farthest to the scanned surface in sub-scanning direction, i.e., those with largest difference between their oblique incidence angle, the color shift may be reduced upon layering colors by a color unit (color image forming apparatus), that, in turn, achieves a high-quality color image. For example, the light-beam sets from the area A in FIG. 6B are provided with the odd numbers of the folding mirror(s) 30. On the other hand, the light-beam sets from the area B are provided with the even numbers of the folding mirrors 30. In this manner, the direction of the scanning line curves can be aligned for all of the light-beam sets. Therefore, the color shift may be reduced upon layering colors in a color imaging apparatus.

Another example of the optical scanning device, the one of bidirectional scanning system, is explained in which a plurality of light-beam sets are incident to different reflecting surfaces of the same deflector.

In contrast to the unidirectional scanning system, in the bidirectional scanning system, a plurality of sets of light beams are incident from both sides of the normal line of the reflecting surface of the deflector, i.e., a polygon mirror. In the optical scanning device of this type, in addition to the advantages described above, the angle for the oblique-incident optical system in the sub-scanning direction, i.e., the angle of the light beams with respect to the normal line of the reflecting surface of the deflector, can be reduced, compared with unidirectional scanning system. In this manner, the scanning line curvature, a problem unique to the oblique-incident optical system, can be reduced.

According to the embodiments, an oblique-incident optical system can be achieved at low cost for a full-color image forming apparatus having a multi-beam with improved speed and density while ensuring high optical performance and low power consumption.

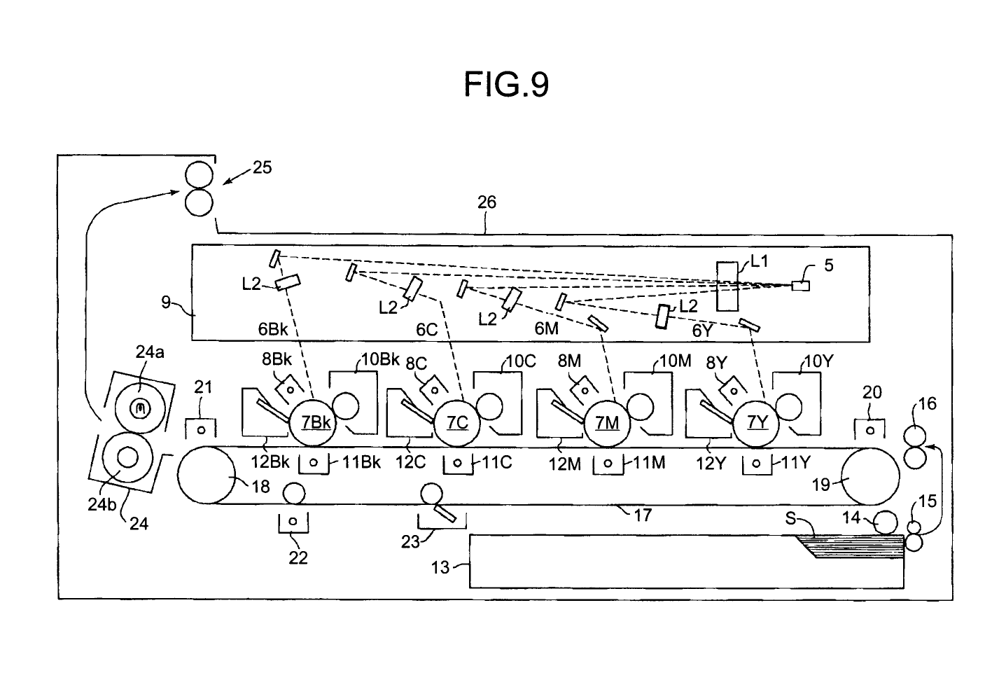

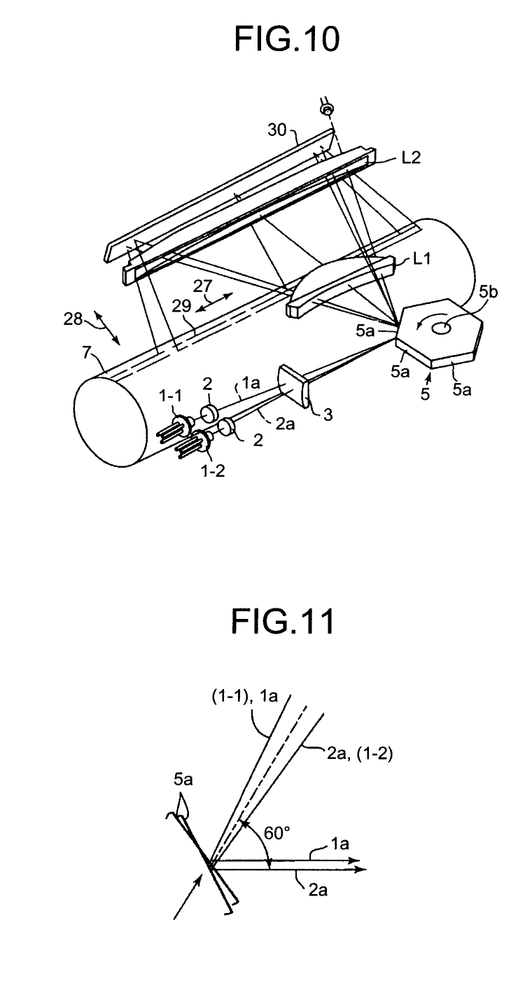

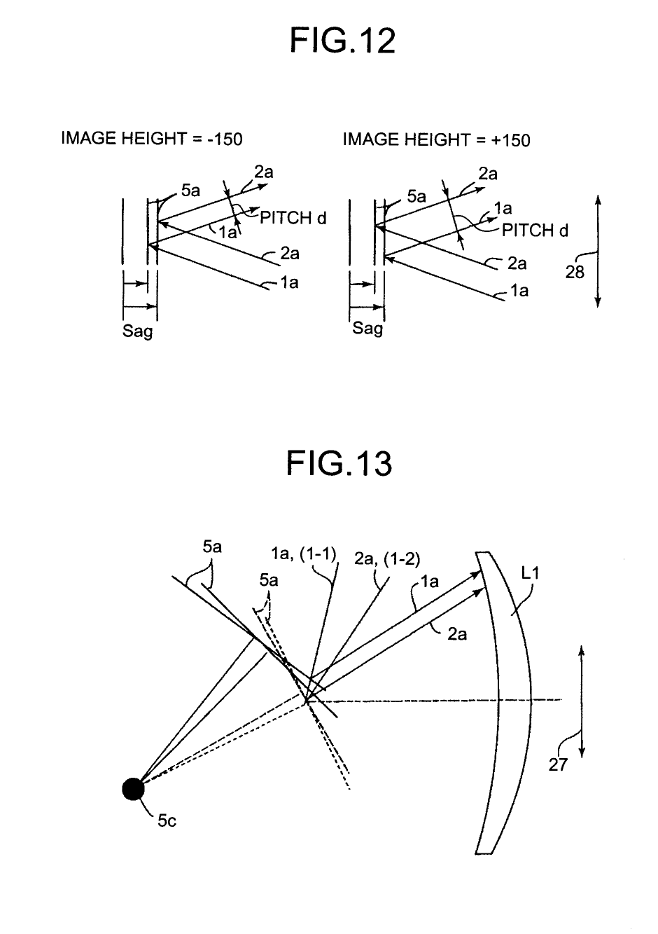

FIG. 9 is a schematic diagram of an image forming apparatus with the optical scanning device of the embodiments. In the following, the image forming apparatus is explained as a tandem full-color laser printer.

The laser printer includes an endless transfer belt 17 that conveys transfer sheets (not shown) from a sheet-feeding cassette 13 arranged horizontally. The endless transfer belt 17 extend around a driving pulley 18 and a driven roller 19, and is driven to move in a direction indicated by an arrow in FIG. 9. Above the endless transfer belt 17 are arranged photoconductors 7Y for yellow (Y), 7M for magenta (M), 7C for cyan (C), and 7Bk for black (Bk) with the same spacing sequentially from upstream to downstream in a feeding direction of the transfer sheets. It is noted that suffixes Y, M, C, and Bk attached to reference numbers indicate that corresponding components are associated with colors: yellow, magenta, cyan, and black. The photoconductors 7Y, 7M, 7C, and 7Bk are formed to have the same diameter, and processing members are sequentially provided on the circumference of each, to execute each step of the electrophotographic process.

For example, on the circumference of the photoconductor 7Y, a charger 8Y, a scanning-imaging optical system 6Y included in an optical scanning device 9, an image developer 10Y, a transferring charger 11Y, and a cleaner 12Y are sequentially arranged. The same applies to the other photoconductors 7M, 7C, and 7Bk. In other words, the surfaces of the photoconductor 7Y, 7M, 7C, and 7Bk, each corresponding to one color, are scanned or irradiated, and scanning-imaging optical systems 6Y, 6M, 6C, and 6Bk are provided in one-to-one correspondence with them. One exception is a lens L1 that is a scanning-imaging element shared among Y, M, C, and Bk. On the circumference of the endless transfer belt 17, a pair of registration rollers 16 and belt charger 20 are provided at upstream of the photoconductor 7Y. To the downstream of the photoconductor 7Bk in the circulating direction of the endless transfer belt 17, a belt separation charger 21, a belt-neutralizing charger 22, and a belt cleaner 23 are sequentially provided. Further to the downstream of the belt separation charger 21 in the direction the transfer sheets are fed, there provided is a fixer 24 including a heating roller 24a and a pressing roller 24b, which are pressed against each other in contact. The fixer 24 is connected to a pair of sheet-discharge rollers 25 leading to a sheet-discharge tray 26.

The operation of the tandem full-color laser printer, whose structure is as summarized above, is explained below. If the printer is in a full-color mode (multi-color mode), each set of light beams from the optical scanning imaging systems 6Y, 6M, 6C, and 6Bk scans, based on an image signal corresponding to each color, each photoconductor 7Y, 7M, 7C, and 7Bk to form a latent image for each color signal on the surface thereof. In the corresponding developer 10Y, 10M, 10C, or 10BK, each latent image is sequentially developed using the toners of each color, and layered on a transfer sheet S, which sticks to the endless transfer belt 17 by way of static electricity. In this manner, a full color image is formed on the transfer sheet S. Then the full color image is fixed with fixer 14, and ejected onto the sheet-discharge tray 26 via the pair of sheet-discharge rollers 25.

FIG. 9 depicts the tandem-type color image forming apparatus using a direct-transfer method, where the images are sequentially transferred and layered as the transfer sheet S (sheet-like recording medium) being conveyed on the endless transfer belt 17. However, the present invention can be applied to other image forming apparatuses, such as a tandem image forming apparatus where the images are first transferred to an intermediary photoconductor having a shape of endless transfer belt, and then are transferred all at once to the transfer sheet S. The present invention can also be applied with the same effect to image forming apparatuses having only a single photoconductor having the form of endless belt.

As set forth hereinabove, according to an embodiment of the present invention, sub-scanning beam-pitch variation can be reduced in an optical scanning device of oblique-incident optical system.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical scanning device comprising:
a deflector that has a deflection-reflecting surface, and deflects light beams on the deflection-reflecting surface; and
a scanning optical system that scans and focuses the light beams on a target surface with a predetermined spacing between the light beams in a sub-scanning direction, wherein
the light beams are incident to the deflection-reflecting surface at angles with respect to a normal of the deflection-reflecting surface in the sub-scanning direction, and incident to the deflection-reflecting surface at substantially identical angles in a main scanning direction.

2. The optical scanning device according to claim 1, wherein the light beams are incident to the deflection-reflecting surface at different angles with respect to the normal of the deflection-reflecting surface in the sub-scanning direction, and are focused on different target surfaces.

3. The optical scanning device according to claim 2, wherein all light beams are incident to the deflection-reflecting surface at different angles with respect to the normal of the deflection-reflecting surface in the sub-scanning direction, and are focused on the different target surfaces.

4. The optical scanning device according to claim 1, further comprising a beam spacer that moves the light beams closer in the main scanning direction.

5. An image forming apparatus that electrophotographically forms an image on a recording medium, the image forming apparatus comprising:
an image carrier; and
the optical scanning device according claim 1 that exposes the image carrier in an electrophotographic manner.

6. An image forming apparatus that electrophotographically forms an image on a recording medium, the image forming apparatus comprising:
at least two image carriers; and
the optical scanning device according claim 2 that exposes the image carriers in an electrophotographic manner.

7. An image forming apparatus that electrophotographically forms an image on a recording medium, the image forming apparatus comprising:
at least two image carriers; and
the optical scanning device according claim 4 that exposes the image carriers in an electrophotographic manner.

8. An optical scanning device comprising:
a light source that emits light beams;
a deflector that has a deflection-reflecting surface, and deflects the light beams on the deflection-reflecting surface; and
a scanning optical system that scans and focuses the light beams on a target surface with a predetermined spacing between the light beams in a sub-scanning direction, wherein
the light beams are incident to the deflection-reflecting surface at angles with respect to a normal of the deflection-reflecting surface in the sub-scanning direction, and incident to the deflection-reflecting surface at different angles in a main scanning direction such that the light beams intersect one another at a position in proximity of the deflection-reflecting surface, and
the position is in between where a distance from the light source to a point on the deflection-reflecting surface from which the light beams are deflected is shortest and where the distance is longest upon rotation of the deflector to deflect the light beams.

9. The optical scanning device according to claim 8, wherein the light beams are incident to the deflection-reflecting surface at different angles with respect to the normal of the deflection-reflecting surface in the sub-scanning direction, and are focused on different target surfaces.

10. The optical scanning device according to claim 9, wherein all light beams are incident to the deflection-reflecting surface at different angles with respect to the normal of the deflection-reflecting surface in the sub-scanning direction, and are focused on the different target surfaces.

11. The optical scanning device according to claim 8, further comprising a beam spacer that moves the light beams closer in the main scanning direction.

12. An image forming apparatus that electrophotographically forms an image on a recording medium, the image forming apparatus comprising:
an image carrier; and
the optical scanning device according claim 8 that exposes the image carrier in an electrophotographic manner.

13. An image forming apparatus that electrophotographically forms an image on a recording medium, the image forming apparatus comprising:
at least two image carriers; and
the optical scanning device according claim 9 that exposes the image carriers in an electrophotographic manner.

14. An image forming apparatus that electrophotographically forms an image on a recording medium, the image forming apparatus comprising:
at least two image carriers; and
the optical scanning device according claim 11 that exposes the image carriers in an electrophotographic manner.
